(19) United States
(12) Patent Application Publication
(10) Pub. No.: US 2005/0177460 A1
(43) Pub. Date: Aug. 11, 2005

(54) Method and system for supplying customized product catalogs

(76) Inventors: Ralph J. Salerno, Buffalo, NY (US); Brian V. DeCicco, Amherst, NY (US)

Correspondence Address: HODGSON RUSS LLP, ONE M & T PLAZA, SUITE 2000, BUFFALO, NY, 14203-2391, US

(21) Appl. No.: 10/752,165

(22) Filed: Jan. 6, 2004

(51) Int. Cl. G06F 17/60

(52) U.S. Cl. 705/27

(57) ABSTRACT

Product catalogs having standard and customized content are supplied using a Web site system that includes a product catalog order form allowing a user to electronically transmit an order for copies of a product catalog to the Web site system, an orders database for storing information associated with product catalog orders, and secure Web pages for displaying the information stored in the orders database and transferring orders for imprinting. The Web site system can be accessed by authorized parties, including a printer printing product catalog templates and an imprinting service that imprints the customized content onto the product catalog templates using high speed imprinting equipment.

### FIELD OF THE INVENTION

The invention concerns a method and system for fulfilling orders for printed copies of product catalogs from various requesting parties, wherein the product catalogs include standard content common to all orders and customized content specific to a particular order.

### BACKGROUND OF THE INVENTION

It is commonplace in the distribution of commercial goods to have a distributor acting as an intermediary between the manufacturer of the goods and a large number of local dealers within a designated geographic region. As part of the distribution and sales effort, the distributor makes brochures and other product literature available to the local dealers, who in turn make the brochures and product literature available to customers. For example, a distributor will allow its local dealers to order bulk quantities of a brochure detailing a particular product line, which the dealers will order when supplies of the brochure run low or an updated brochure becomes available. The brochure contains “standard content” (i.e. the product descriptions) that appears in all copies of the brochure and “customized content” (i.e. the dealer's logo and contact information) that is specific to a particular local dealer and that differs from dealer to dealer. The customized content is typically confined to a predetermined block area on the front cover of the brochure.

Printing companies commissioned to fill the orders have heretofore imprinted the pages of the catalog and created a cover page block for imprinting the cover page containing the customized content such as the dealer contact information and logo. The printed pages are then assembled to provide a completed product catalog. While this traditional method provides product catalogs of high quality, it requires significant set-up man hours, occupies printing equipment, and is characterized by slow turnaround times for filling orders, especially when a large number of orders are received at a given time.

### SUMMARY OF THE INVENTION

The present invention provides a method and system for fulfilling product catalog orders in a more efficient manner than the traditional approach. A method according to the present invention generally comprises the steps of providing a Web site system that includes a product catalog order form allowing a user to electronically transmit an order for copies of a product catalog, the order including customized content to appear in the copies of the product catalog and a desired quantity of copies of the product catalog; receiving the order and recording the order in a database of orders, the database having a field containing a value indicating whether the order has been transferred for imprinting; transferring the order to an imprinting service and changing the value of the field to indicate the order has been transferred for imprinting; providing preprinted copies of a product catalog template corresponding to the ordered product catalog, the product catalog template having standard content and an area for placing the customized content; and imprinting the customized content onto copies of the product catalog template to produce the desired quantity of copies of the product catalog. Under this method, it is preferred to transfer an order to an imprinting service running bulk mail imprinting equipment, whereby the equipment is used to imprint only the customized content onto preprinted and preassembled copies of the product catalog template. If the imprinting service has a computer, the order information can be transmitted in an attachment to an e-mail sent from the Web site system.

The invention also covers Web site system for managing orders for product catalogs having standard content and customized content. The Web site system generally comprises a product catalog order form allowing a user to electronically transmit an order for copies of a product catalog to the Web site system, the order including customized content to appear in the copies of the product catalog and a desired quantity of copies of the product catalog; an orders database for storing information associated with product catalog orders received by the Web site system, wherein the orders database includes a field containing a value indicating whether an associated order has been transferred for imprinting; and at least one secure Web page for displaying the information stored in the orders database. In a preferred Web site system of the present invention, the product catalog order form is accessible from the product distributor's Web site system by hyperlink. The Web site system preferably also comprises a secure Web page including a command object for initiating transfer of a batch of orders for imprinting.

The invention is further embodied in a business system for supplying product catalogs having standard content and customized content. The business system generally comprises a Web site system that includes a product catalog order form allowing a user, such as a local dealer, to electronically transmit an order for copies of a product catalog, the order including customized content to appear in the copies of the product catalog and a desired quantity of copies of the product catalog; an orders database for storing information associated with product catalog orders received by the Web site system; copies of a product catalog template corresponding to the ordered product catalog, the product catalog template having the standard content and an area for placing the customized content; and an imprinting service in communication with the orders database, the imprinting service having imprinting equipment loadable with the copies of the product catalog template and programmable to imprint the copies of the product catalog template with the customized content within the area for placing the customized content to produce the desired quantity of copies of the product catalog.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram showing an embodiment of the present invention;

FIG. 2A is a screen capture showing a portion of a product catalog order form Web page in accordance with an embodiment of the present invention;

FIG. 2B is a screen capture showing another portion of the product catalog order form Web page of FIG. 2A;

FIG. 3 is a screen capture showing an order proof Web page in accordance with an embodiment of the present invention;

FIG. 4 is a screen capture showing an order confirmation Web page in accordance with an embodiment of the present invention;

FIG. 5 is a screen capture showing a sign-in Web page through which authorized personnel may access print order program in accordance with an embodiment of the present invention;

FIG. 6 is a screen capture showing a Web page associated with the print order program for displaying information relating to untransferred orders in accordance with an embodiment of the present invention;

FIG. 7 is a screen capture showing a Web page associated with the print order program for displaying information relating to transferred orders in accordance with an embodiment of the present invention;

FIG. 8 is a screen capture showing a Web page associated with the print order program for transferring a batch of orders in accordance with an embodiment of the present invention;

FIG. 9 is a screen capture showing-a Web page associated with the print order program for displaying archival information relating to completed orders in accordance with an embodiment of the present invention; and

FIG. 10 is a screen capture showing a Web page associated with the print order program for displaying information relating to a single selected order in accordance with an embodiment of the present invention.

### DETAILED DESCRIPTION OF THE INVENTION

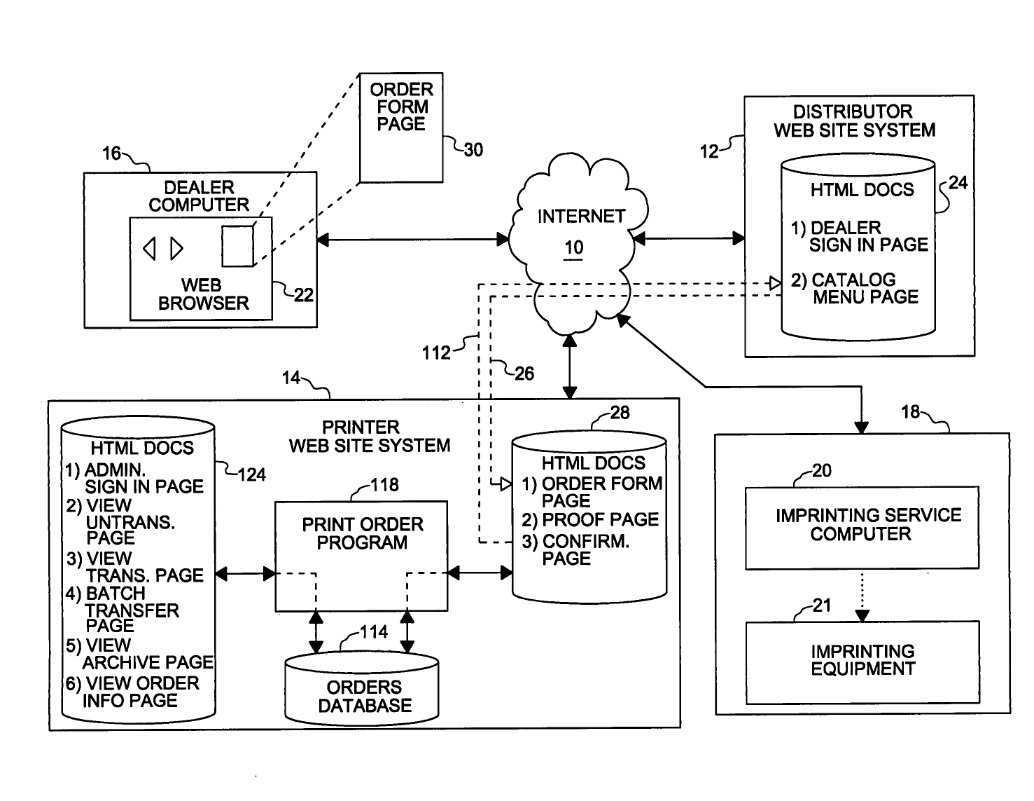

Attention is directed initially to FIG. 1 of the drawings. FIG. 1 schematically illustrates an Internet-based system incorporating the present invention. The system generally comprises a distributor Web site system 12 run by or for a product distributor, a printer Web site system 14 run by or for a printing company, a dealer computer 16 run by or for a local dealer selling products handled through the distributor, and an imprinting service 18 including an imprinting service computer 20. As indicated in FIG. 1, the distributor Web site system 12, printer Web site system 14, dealer computer 16, and imprinting service computer 20 are connected to one another via the Internet 10. As used herein, the term “Web site system” is to be broadly construed as including hardware and/or software used in maintaining a Web site on the World Wide Web. For example, a Web site system typically includes one or more Web servers and/or personal computers electronically connected to the Internet, as well as HTML documents, database files, Web server software, and other files stored on the Web server(s) and used in maintaining a Web site.

In FIG. 1, the distributor Web site system 12 is intended to reach local dealers, who are able to access the distributor Web site system 12 using dealer computer 16 running a browser program 22, such as Microsoft Internet Explorer, Netscape Navigator, or any other suitable Web browser program. Distributor Web site system 12 has various HTML documents 24, including a dealer sign-in Web page and-a catalog menu Web page enabling an authorized dealer to select a particular product catalog offered by the distributor if the dealer wishes to place an order for copies of the catalog. Upon selection of a particular product catalog, the dealer is seamlessly routed by way of a hyperlink 26 to the printer Web site system 14, which is designed to receive and help fill the dealer's order for product catalogs. As will be understood, the printing company behind printer Web site system 14 is commissioned by the distributor to fill product catalog orders.

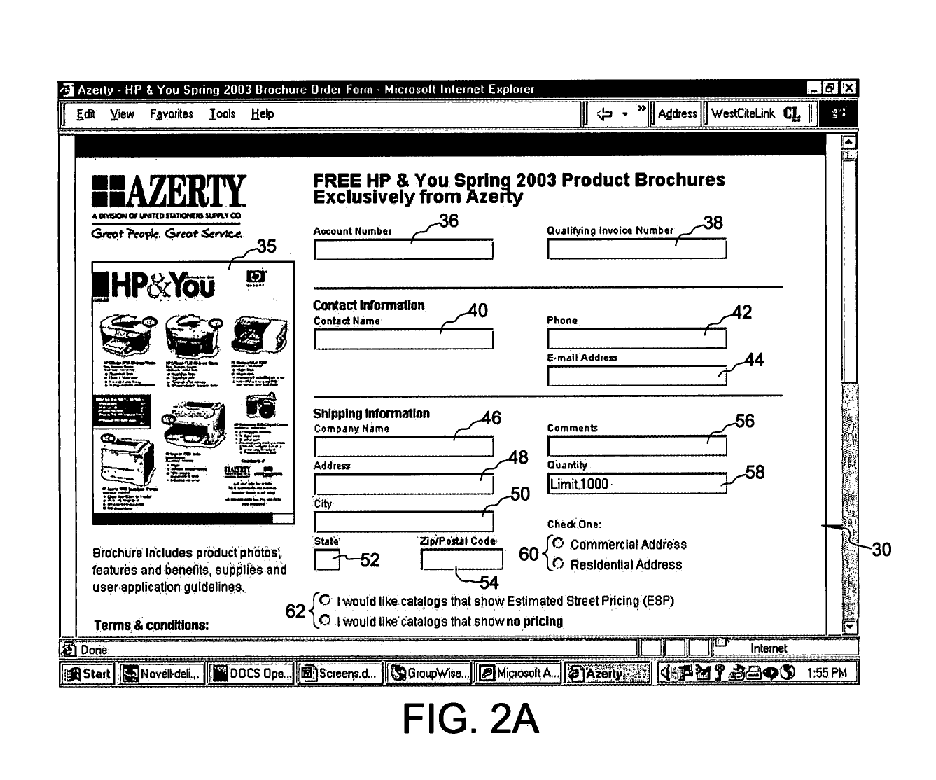

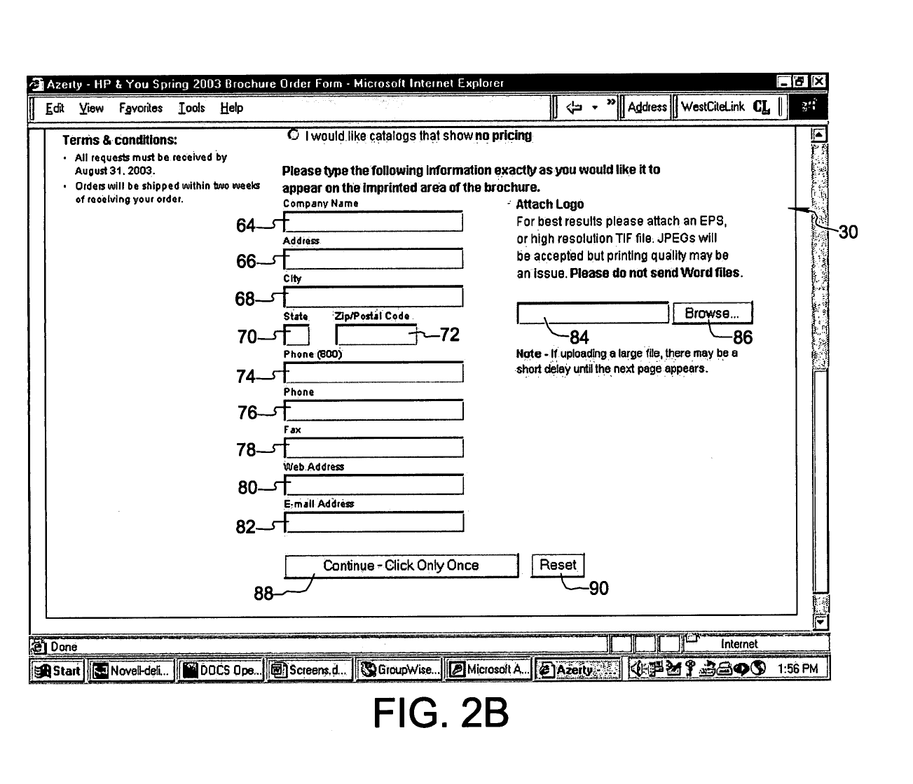

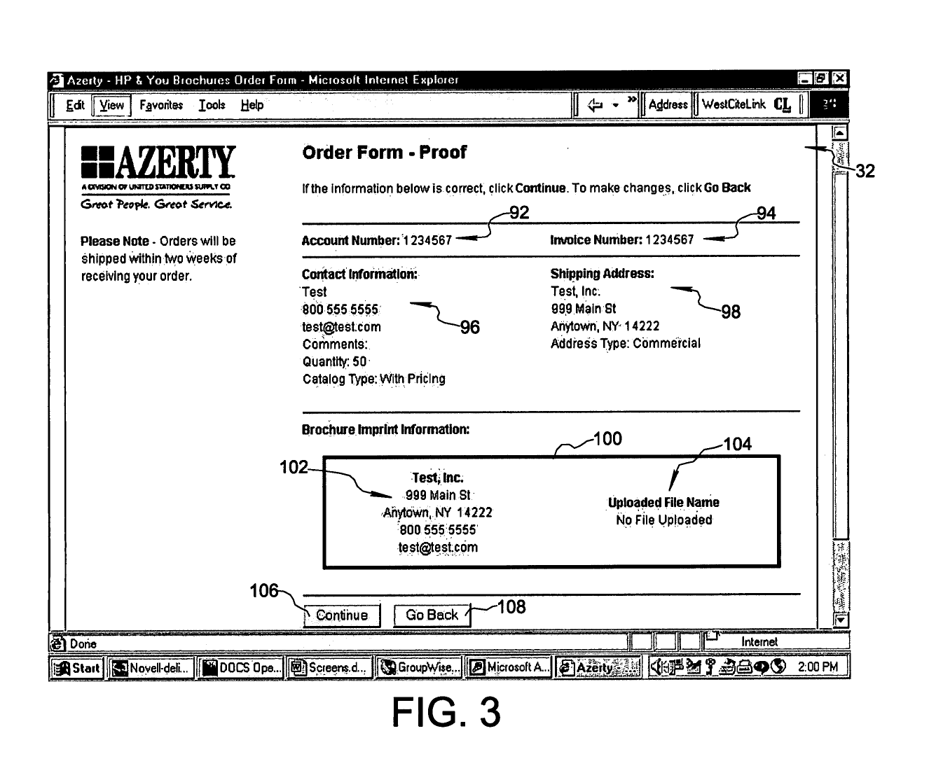

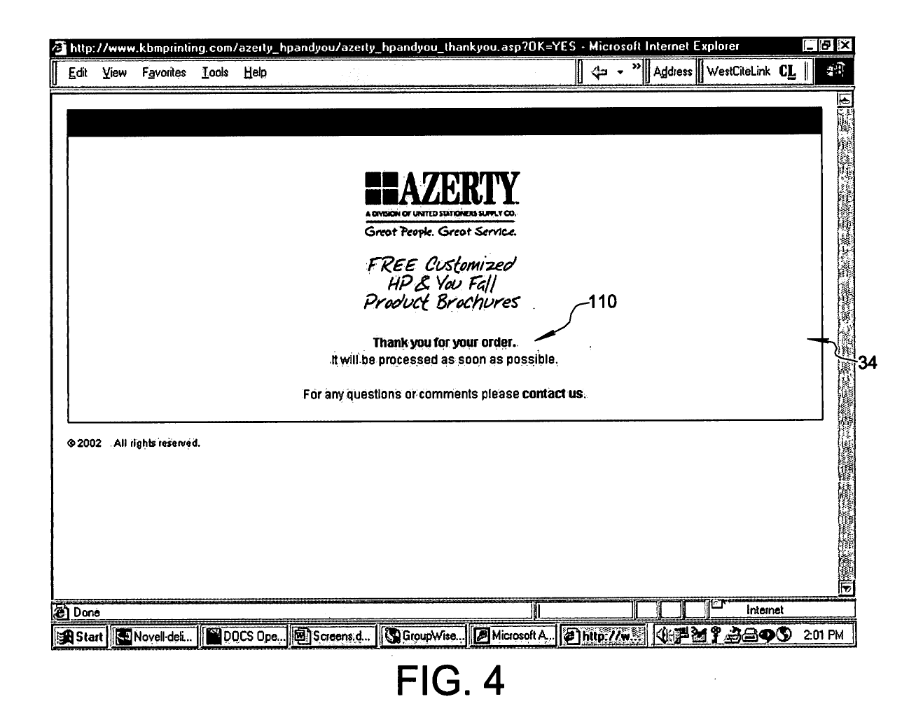

The printer Web site system 14 includes various HTML documents 28 preferably having the look and feel of Web pages associated with distributor Web site system 12, in particular a product catalog order form Web page 30 as shown in FIGS. 2A and 2B, an order proof Web page 32 as shown in FIG. 3, and an order confirmation Web page 34 as shown in FIG. 4. Hyperlink 26 causes product catalog order form Web page 30 to be displayed by Web browser 22 running on dealer computer 16. Catalog order form 30 is shown as including an image 35 of the product catalog cover, a text box 36 for entering an account number and a text box 38 for entering an invoice number. Catalog order form 30 also includes text boxes 40, 42, and 44 for entering a name, telephone number, and e-mail address of a dealer contact, respectively. Catalog order form 30 further includes a text box 46 for entering a company name of the dealer, and text boxes 48, 50, 52 and 54 for entering a dealer address, city, state and postal code. Other text boxes on catalog order form 30 include a text box 56 allowing the dealer to enter comments, and a text box 58 allowing the dealer to enter a desired quantity of copies of the product catalog being ordered. A pair of option buttons 60 on catalog order form 30 allow the dealer to indicate whether an entered address is a commercial address or a residential address. Another pair of option buttons 62 allow the dealer to choose catalogs that show estimated street pricing for listed products or catalogs that do not.

Reference is now made specifically to FIG. 2B, which shows a portion of catalog order form 30 that allows the dealer to enter customized content to appear in the product catalogs being ordered. A plurality of text boxes are provided to enter dealer contact information to be imprinted on the products catalogs, as follows: a text box 64 for entering a company name, a text box 66 for entering an address, a text box 68 for entering a city, a text box 70 for entering a state, a text box 72 for entering a postal code, a text box 74 for entering a toll free telephone number, a text box 76 for entering another telephone number, a text box 78 for entering a fax number, a text box 80 for entering a Web site address, and a text box 82 for entering an e-mail address. The portion of catalog order form 30 for entering customized content also includes a text box 84 for entering a filename and path string identifying an image file storing an image, such as a logo, that the dealer would like imprinted on the copies of the product catalog. A command button 86 associated with text box 84 allows the dealer to browse the directory of dealer computer 16 to help locate a suitable image file and automatically type the proper filename and path string into text box 84. Finally, a “continue” command button 88 and a “reset” command button 90 are provided at the bottom of catalog order form 30. Clicking the continue command button 88 causes the order information entered by the dealer to be transmitted to printer Web site system 14, which uses the information to generate and transmit order proof Web page 32 for display on dealer computer 16. Clicking reset command button 90 clears the various text boxes and option buttons on catalog order form 30 so the dealer may start fresh.

As mentioned, when continue command button 88 is clicked, order proof Web page 32 is displayed on dealer computer 16. FIG. 3 shows order proof Web page 32 according to an embodiment of the present invention. Order proof Web page 32 preferably includes an account number proof section 92 displaying information entered in text box 36, an invoice number proof section 94 displaying information entered in text box 38, a contact information proof section 96 displaying information entered in text boxes 40, 42, 44, 56, and 58 and in option buttons 62, and a shipping address proof section 98 displaying information entered in text boxes 46, 48, 50, 52, and 54 and in option buttons 60. Order proof Web page 32 further includes an imprint proof area 100 that represents the physical area on each copy of the product catalog that will be imprinted with the customized content and serves to show the layout of the customized content as it will appear on the product catalogs. A left hand portion 102 of imprint proof area 100 includes the information entered in text boxes 64, 66, 68, 70, 72, 74, 76, 78, 80, and 82. A right hand portion 104 of imprint proof area 100 shows either the path and filename of an image file identified in text box 84, or a representation of the corresponding image itself. If the dealer is satisfied the information entered in catalog order form 30 is correct, it can click a “continue” command button 106 provided at the bottom of order proof Web page 32; if not, the dealer can click “go back” command button 108 provided next to continue command button 106. Clicking continue command button 106 causes order confirmation Web page 34 containing an order confirmation message 110 to be displayed for a brief time before a coded hyperlink 112 places dealer computer 16 back into communication with distributor Web site system 12. In addition, clicking continue command button 106 causes the order information and image file entered in the various input objects on catalog order form 30 to be uploaded and written to corresponding fields in an orders database 114 associated with printer Web site system 14 to create a new record of the order in the orders database, including a field referencing the image file in an upload directory on printer Web site system 14. Clicking go back command button 108 causes flow to revert back to catalog order form 30 shown in FIGS. 2A and 2B.

As will be understood from the foregoing description, printer Web site system 14 cooperates with distributor Web site system 12 to allow dealers to electronically place orders for desired quantities of product catalogs containing customized content. In accordance with the present invention, printer Web site system 14 is also designed to help the printer fill the orders in a novel manner that allows the product catalogs to be preprinted and assembled as “product catalog templates” in advance of or in response to dealer orders, and the customized content imprinted onto copies of the product catalog template after the assembly step using imprinting equipment other than that used for printing the product catalog templates. Accordingly, the printer can use its in-house printing press equipment to print all pages of the catalog, leaving a designated area on the cover page blank for later placement of the customized content, and assemble the pages by folding and binding them to produce stock quantities of product catalog templates. Then, as dealer orders are received, the product catalog templates can be imprinted with the customized content, preferably using less sophisticated bulk mailing equipment located either at the printer's shop or at a “bulk mail house” service specializing in bulk mailing services. As will be described below, printer Web site system 14 allows authorized personnel to view and “transfer” orders for imprinting customized content onto a desired number of copies of the corresponding product catalog template to fill the orders.

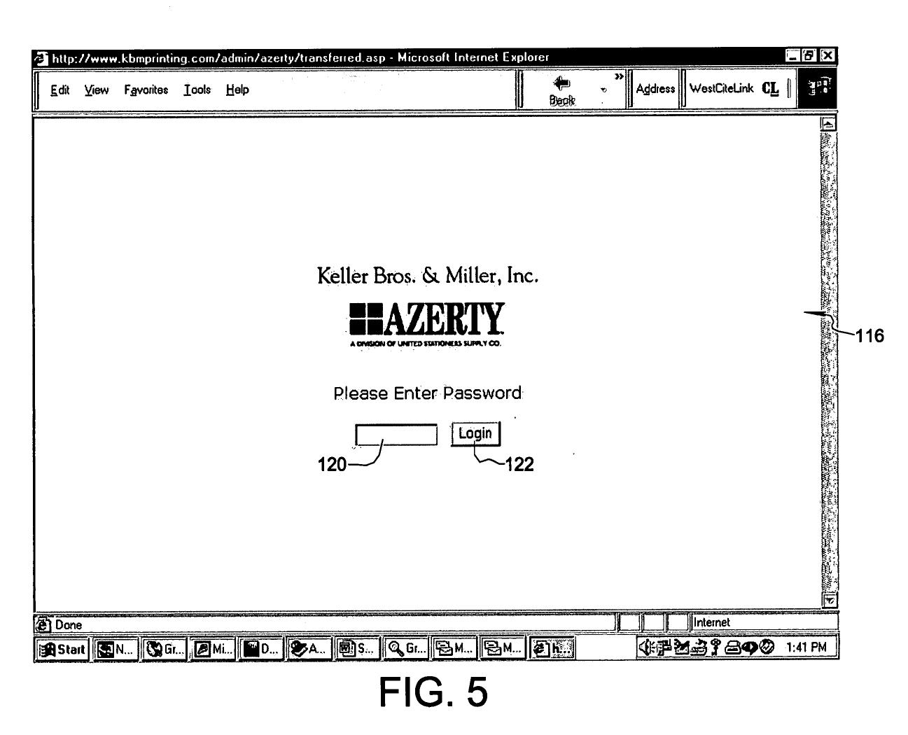

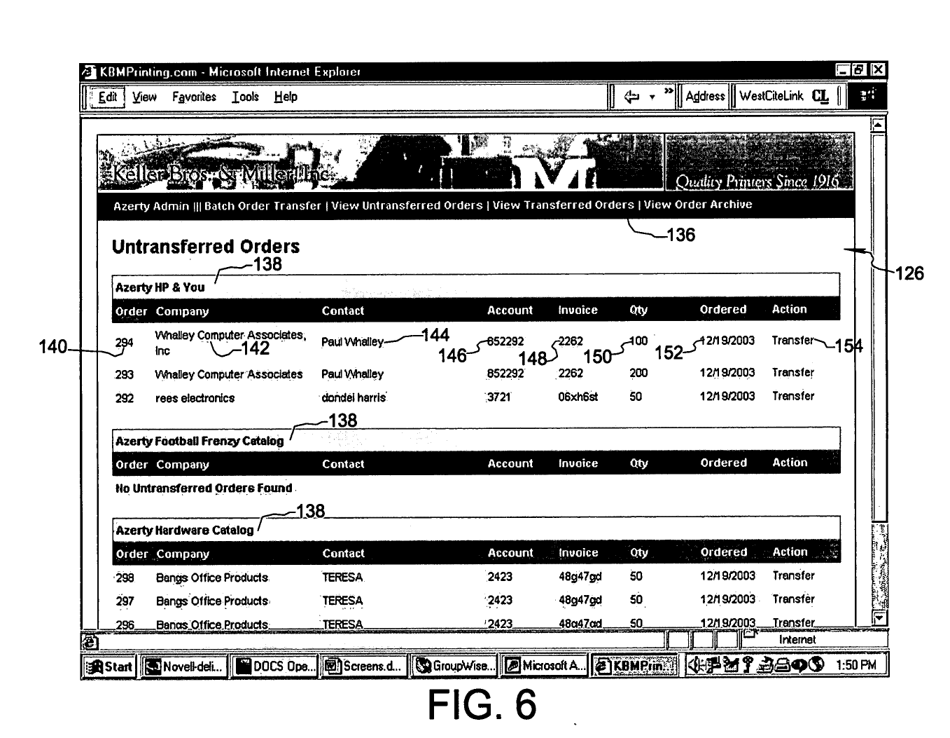

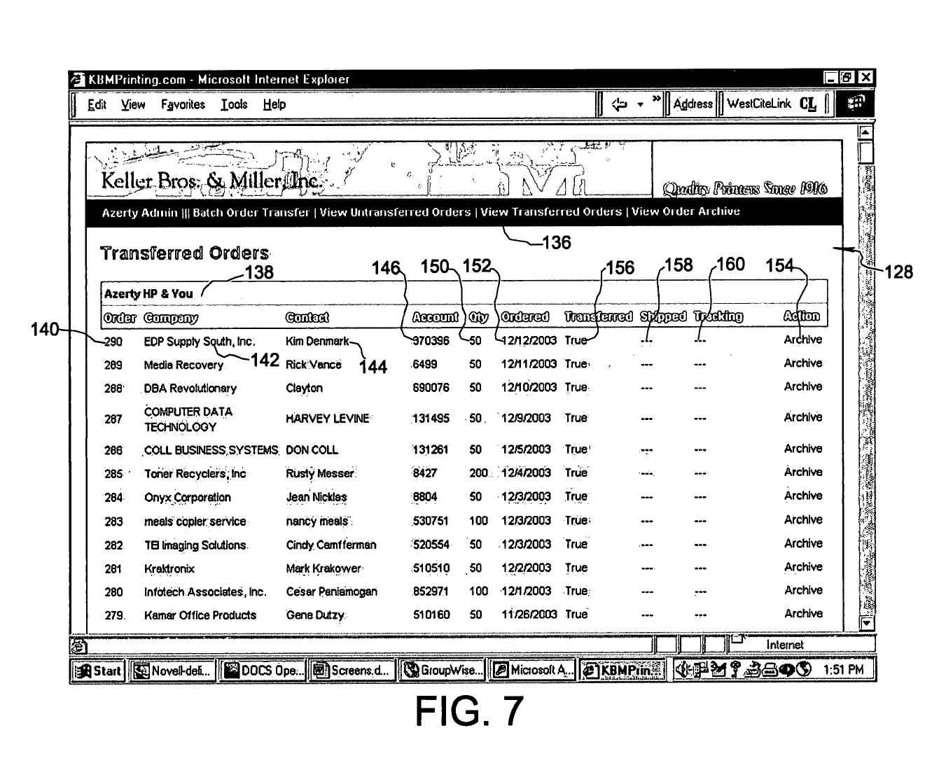

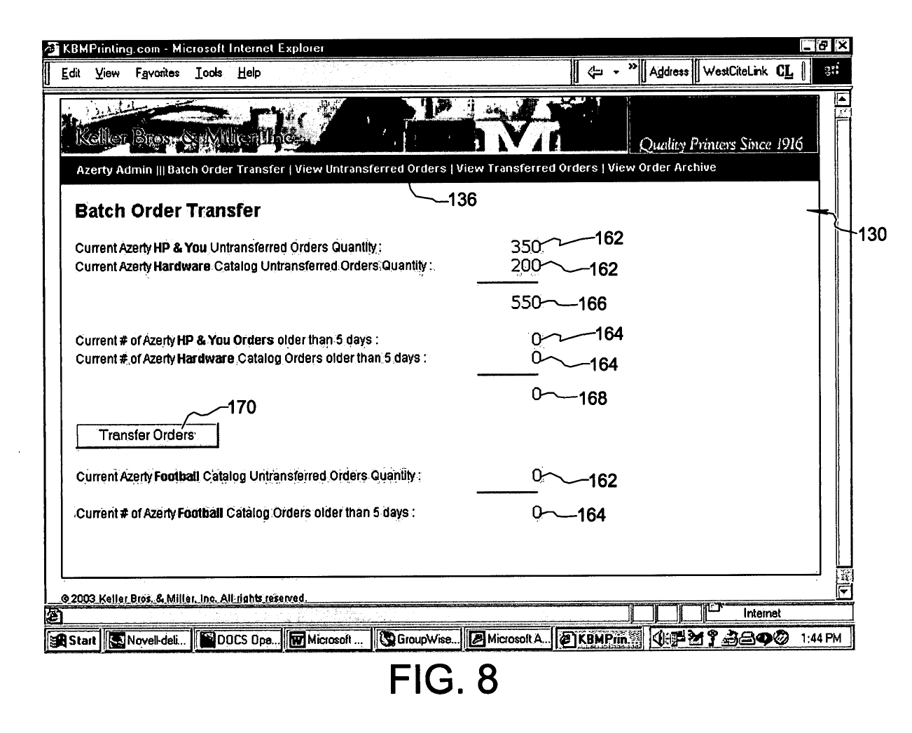

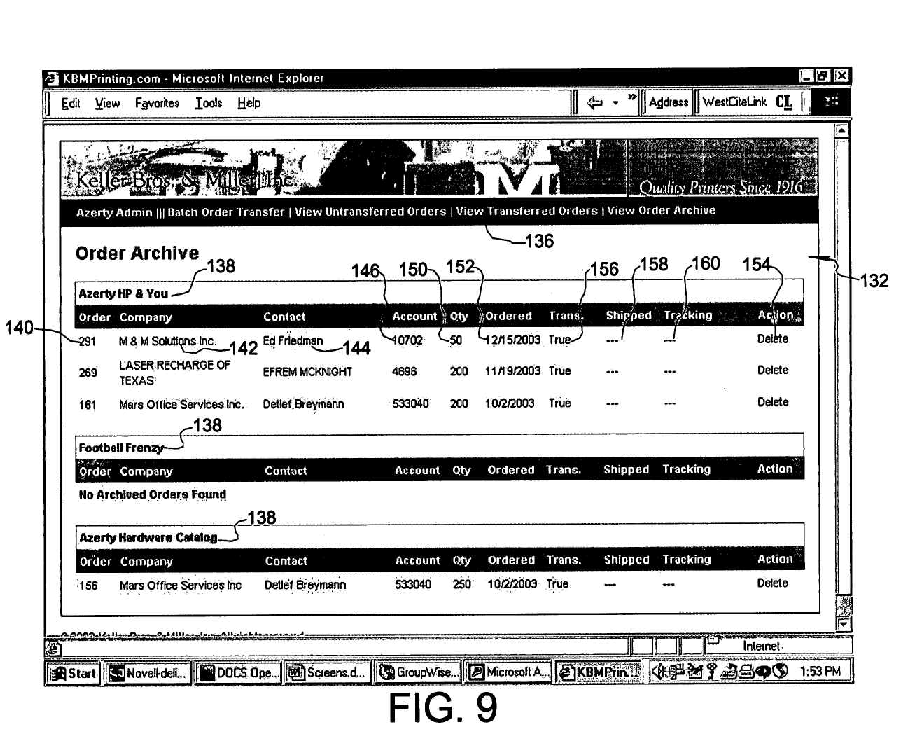

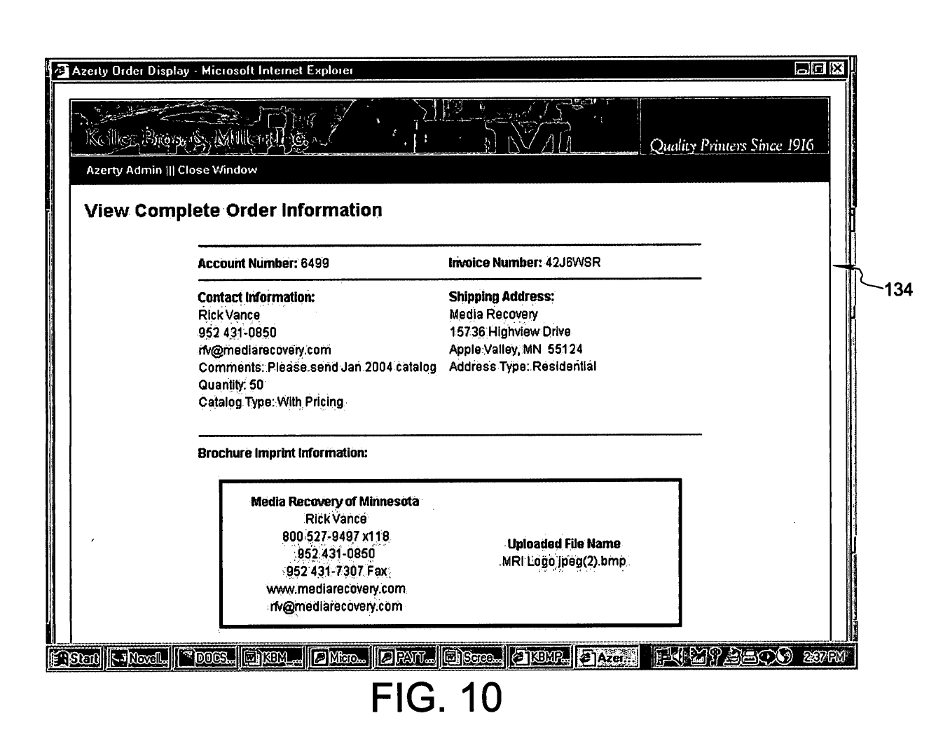

FIG. 5 shows a sign-in Web page 116 through which personnel authorized by the printer may interface with a print order program 118 tied to orders database 114 in accordance with an embodiment of the present invention. The sign-in Web page 116 includes a text box 120 for entering an assigned password, and a “login” command button 122 that is clicked after the password is entered to gain access to various secure HTML documents 124 associated with print order program 118. HTML documents 124 include a Web page 126 as shown in FIG. 6 for displaying information relating to untransferred orders, a Web page 128 as shown in FIG. 7 for displaying information relating to transferred orders, a Web page 130 as shown in FIG. 8 for transferring a batch of orders, a Web page 132 as shown in FIG. 9 for displaying archival information relating to completed orders, and a Web page 134 as shown in FIG. 10 for displaying information relating to a single selected order. All of the Web pages shown in FIGS. 6-9 include a menu bar 136 for switching among the corresponding Web pages shown in those figures.

Reference is now made to FIG. 6. Web page 126 displays information relating to orders that have not yet been “transferred” for imprinting. Orders database 114 includes a “transferred” field 156 (see FIG. 7) having two possible values, “true” and “false,” to indicate whether the corresponding order has been transferred for imprinting. Accordingly, the records in the orders database can be filtered using the “transferred” field to show only untransferred orders. The order records are grouped based on the particular product catalog ordered, as indicated by product catalog headings 138. The following fields are displayed for each untransferred order: an order identification number field 140 which stores a unique numerical value automatically assigned when the order record is appended to the database, a company name field 142 storing text entered at text box 46 of catalog order form 30, a contact field 144 storing text entered at text box 40 of catalog order form 30, an account number field 146 storing text entered at text box 36 of catalog order form 30, an invoice number field 148 storing text entered at text box 38 of catalog order form 30, a quantity field 150 storing the desired quantity of product catalogs entered at text box 58 of catalog order form 30, an ordered field 152 storing the date on which the order was received, and an action field 154 indicating the next action to be taken with respect to the corresponding order, i.e. “transfer” or “archive”. Values displayed in order identification number field 140 are hyperlinks that can be double-clicked to reveal a pop-up window 134, shown in FIG. 10, displaying additional details about the particular order in a format that is similar to the format used for order proof Web page 32. Double-clicking the contact name in contact field 144 initiates an e-mail message to the contact based on the e-mail address entered at text box 44 of catalog order form 30. Finally, clicking the word “transfer” in the action field initiates a “transfer” of the order for imprinting the customized content onto product catalog templates, as will be described in detail below with reference to a batch order transfer.

Web page 128 of FIG. 7 displays information relating to transferred orders only, which can be realized by filtering the database records to yield only those records where the value of transferred field 156 is “true”. The order records are grouped under product catalog headings 138 and the following fields are displayed: order identification number field 140, company name field 142, contact field 144, account number field 146, quantity field 150, ordered field 152, transferred field 156, a shipped field 158 for storing a shipping date associated with the order, a tracking field 160 for storing a shipper tracking number associated with the order, and action field 154. Similar to previous Web page 126, double clicking a value in order identification number field 140 displays additional order details and double-clicking a value in contact, field 144 initiates an e-mail message to the contact. Double clicking “archive” in action field 154 in effect deletes the order from the record set of active orders and includes the order in a recordset of archived orders, which are displayed by way of Web page 132 shown in FIG. 9.

As mentioned above, untransferred orders displayed on Web page 126 can be transferred for imprinting in accordance with the present invention. In the embodiment represented in FIG. 1, imprinting is carried out by an imprinting service 18. It is understood that “imprinting service” means any combination of imprinting equipment and operating personnel, whether provided as part of the business operation of the printer or as a separate business operation. In a particular embodiment of the invention, imprinting service 18 is a bulk mail house having a computer 20 and imprinting equipment 21. It is recognized that the printing quality demanded for the standard content in product catalogs (i.e. product photographs, descriptions, etc.) is quite high relative to that required for the customized content (i.e. dealer contact information and logo). Consequently, the present invention is preferably practiced using bulk mail equipment normally used for addressing and placing a bar code image on bulk mail items because this equipment is designed to rapidly imprint large quantities of documents. Rather than imprinting a bar code image, the equipment can be programmed to imprint an image of the dealer's logo as supplied by individual dealers. It will be appreciated that use of separate equipment for imprinting the customized content frees up the more sophisticate printing equipment for printing more product catalog templates or running unrelated printing jobs.

Transferring an order for imprinting involves transmitting the order to imprinting service 18. Where imprinting service 18 includes a computer 20 used to receive order information, the order is preferably transmitted by electronic mail from printer Web site system 14 to imprinting service computer 20. More specifically, information in fields relevant to imprinting the customized content, including fields storing the dealer contact information and logo image file, is transmitted in a format usable by the imprinting service 18 to program its imprinting equipment 21. The format is open to variation, however under a currently practiced method, the orders database 114 is a Microsoft Access database and data stored in an order record are converted to a comma delimited (.csv) file that is readable using Microsoft Excel. The comma delimited file is transmitted to printing service computer 20 as an e-mail attachment. When an order is transferred for imprinting, the value of the transferred field 156 is changed, either automatically or manually, from “false” to “true”.

As described above, it is possible to transfer orders individually by clicking “transfer” in action field 154 from Web page 126. If this is done, print order program 118 preferably generates a pop-up window (not shown) confirming the transfer transmission e-mail and identifying the created attachment file. However, it may be preferable to transfer all untransferred orders at once as part of a batch transfer of orders, as opposed to transferring the orders one by one. Web page 130 shown in FIG. 8 is provided for this purpose. Web page 130 displays count data relating to the number and age of untransferred orders in orders database 114. For each different product catalog, a count 162 representing the total desired quantity in all untransferred orders and a count 164 representing the total desired quantity in all untransferred orders older than five days are displayed. An aggregate count 166 representing the total desired quantity of product catalogs of any type in all untransferred orders, and an aggregate count 168 representing the total desired quantity of product catalogs of any type in all untransferred orders older than five days, are displayed. A command button 170 on Web page 130 is provided for initiating a batch transfer of orders for imprinting. Where imprinting service 18 includes a computer 20 used to receive order information, the batch of orders is preferably transmitted by electronic mail from printer Web site system 14 to imprinting service computer 20. When command button 170 is clicked, programming code responsive to the click event creates a single file that stores all the relevant information for each untransferred order in a format usable by the imprinting service 18 to program its imprinting equipment 21. As with the transfer of a single order, the file format for a batch transfer is open to choice. In a currently practiced method, a comma delimited (.csv) file that is readable using Microsoft Excel is created and sent as an e-mail attachment to imprinting service computer 20. When a batch of orders is transferred for imprinting, the value of the transferred field 156 in each corresponding order record in orders database 114 is changed, preferably automatically, from “false” to “true”.

At the time an order transmission e-mail (single or batch) is transmitted to the imprinting service computer 20, another e-mail message is automatically generated and sent to each corresponding dealer computer 16 letting the dealer know that its order is being processed.

If the imprinting service 18 does not have a computer 20, or the imprinting service is part of the printer's business operations and not an outside service, there may be no need for electronic transmission of order information, and the step of transferring orders to the imprinting service may simply involve generating a printout and/or displaying the information on a computer at the printer's place of business.

Once the order information has been transferred to the imprinting service 18, the information is acted on to fill the order or batch of orders. In a currently practiced method, imprint equipment 21 is bulk mailing imprint equipment which is loaded by operating personnel with preprinted copies of the product catalog template supplied by the printer, programmed to imprint the customized content onto copies of the product catalog template at the area provided on the template for placing the customized content, and run to produce the desired quantity of copies of the product catalog. The completed copies of the product catalog are then shipped to the shipping address given by the dealer and the order is filled.

As will be appreciated from the foregoing description, the present invention provides a more efficient method and system for fulfilling orders for printed catalogs. Personnel associated with imprinting service 18 can be given a password for accessing the print order program 118 and associated secure Web pages on the printer Web site system 14, such that the imprinting service can periodically visit the printer Web site system and transfer orders for imprinting, and the printer can simply monitor progress by viewing the order information on its own Web site system. The invention allows the printer to print and assemble product catalogs in advance, frees-up printing equipment for other uses and preferably takes advantage of the capabilities of bulk mailing equipment by using the equipment for purposes other than bulk mailing. Moreover, the dealer and distributor benefit from a faster turnaround time on product catalog orders.

1. A method of supplying product catalogs comprising the steps of:
providing a Web site system that includes a product catalog order form allowing a user to electronically transmit an order for copies of a product catalog, the order including customized content to appear in the copies of the product catalog and a desired quantity of copies of the product catalog;
receiving the order and recording the order in a database of orders, the database having a field containing a value indicating whether the order has been transferred for imprinting;
transferring the order to an imprinting service and changing the value of the field to indicate the order has been transferred for imprinting;
providing preprinted copies of a product catalog template corresponding to the ordered product catalog, the product catalog template having standard content and an area for placing the customized content; and
imprinting the customized content onto copies of the product catalog template to produce the desired quantity of copies of the product catalog.

2. The method according to claim 1, further comprising the step of electronically transmitting a proof to the user for confirming that the customized content in the order is correct.

3. The method according to claim 1, wherein the step of transferring the order to an imprinting service is carried out as part of a batch order transmission of a plurality of orders not previously transferred for imprinting.

4. The method according to claim 3, wherein the Web site system includes a secure web page through which orders recorded in the database can be viewed and the batch order transmission can be initiated.

5. The method according to claim 3, wherein the step of transferring the order to an imprinting service includes transmitting the order by electronic mail to a computer of the imprinting service.

6. The method according to claim 3, further comprising the step of transmitting an electronic mail message to the user indicating that the order is being processed.

7. The method according to claim 1, wherein the step of imprinting the customized content onto copies of the product catalog template includes the substeps of:
loading bulk mailing imprint equipment with preprinted copies of the product catalog template;
programming the bulk mailing imprint equipment to imprint the customized content onto copies of the product catalog template at the area for placing the customized content; and
running the bulk mailing imprint equipment to produce the desired quantity of copies of the product catalog.

8. The method according to claim 1, wherein the order includes a delivery address, and the method further comprises the step of forwarding the desired quantity of copies of the product catalog to the delivery address.

9. The method according to claim 8, wherein the delivery address is also at least part of the customized content.

10. The method according to claim 1, wherein the customized content includes text.

11. The method according to claim 1, wherein the customized content includes a logo.

12. A Web site system for managing orders for product catalogs having standard content and customized content, the system comprising:
a product catalog order form allowing a user to electronically transmit an order for copies of a product catalog to the Web site system, the order including customized content to appear in the copies of the product catalog and a desired quantity of copies of the product catalog;
an orders database for storing information associated with product catalog orders received by the Web site system, wherein the orders database includes a field containing a value indicating whether an associated order has been transferred for imprinting; and
at least one secure Web page for displaying the information stored in the orders database.

13. The Web site system according to claim 12, wherein the product catalog order form is accessible from another Web site system by hyperlink.

14. The Web site system according to claim 12, further comprising a proof Web page generated based on the order and transmitted to the user for allowing the user to confirm that the customized content in the order is correct

15. The Web site system according to claim 12, further comprising a secure Web page including a command object for initiating transfer of a batch of orders for imprinting.

16. The Web site system according to claim 15, further comprising programming code for converting the batch of orders to a spreadsheet format attached to an electronic mail message in response to an event involving the command object.

17. A system for supplying product catalogs having standard content and customized content, the system comprising:
a Web site system that includes a product catalog order form allowing a user to electronically transmit an order for copies of a product catalog, the order including customized content to appear in the copies of the product catalog and a desired quantity of copies of the product catalog;
an orders database for storing information associated with product catalog orders received by the Web site system;
copies of a product catalog template corresponding to the ordered product catalog, the product catalog template having the standard content and an area for placing the customized content; and
an imprinting service in communication with the orders database, the imprinting service having imprinting equipment loadable with the copies of the product catalog template and programmable to imprint the copies of the product catalog template with the customized content within the area for placing the customized content to produce the desired quantity of copies of the product catalog.
